(19) United States
(12) Patent Application Publication
(10) Pub. No.: US 2018/0155596 A1
(43) Pub. Date: Jun. 7, 2018

(54) METHODS AND COMPOSITIONS FOR LOWERING ICE TEMPERATURE AND FREEZING POINT OF WATER

(71) Applicant: Randolph Earl Bridwell, Sarasota, FL (US)

(72) Inventor: Randolph Earl Bridwell, Sarasota, FL (US)

(21) Appl. No.: 15/568,522

(22) PCT Filed: Jul. 23, 2015
(86) PCT No.: PCT/US15/41734

§ 371 Date: Oct. 23, 2017

Related U.S. Application Data
(60) Provisional application No. 62/151,624, filed on Apr. 23, 2015.

(51) Int. Cl. C09K 5/20; C09K 5/14

(52) U.S. Cl. CPC C09K 5/20; C09K 5/14

(57) ABSTRACT

A composition for lowering the freezing point of water including at least one compound chosen from sodium chloride in an amount from 0.0001% to 100% volume, magnesium chloride in an amount from 0.0001% to 100% volume, calcium chloride in an amount from 0.0001% to 100% volume, potassium in an amount from 0.0001% to 100% volume, potassium chloride in an amount from 0.0001% to 100% volume, ammonia in an amount from 0.0001% to 100% volume, calcium carbonate in an amount from 0.0001% to 100% volume, magnesium carbonate in an amount from 0.0001% to 100% volume, acetate acid in an amount from 0.0001% to 100% volume, potassium acetate in an amount from 0.0001% to 100% volume, and urea in an amount from 0.0001% to 100% volume. A pretreated product for keeping an item cold. A kit including the composition. A method of lowering the freezing point of water.

### 1. TECHNICAL FIELD

The present invention relates to methods and compositions for lowering ice temperature and freezing point of water.

### 2. BACKGROUND ART

Lowering the freezing point of ice or keeping products at a temperature lower than freezing is desirable in several different circumstances. For example, people have used sodium chloride in different forms such as table salt, rock salt, and other forms to lower the freezing point of ice to be used to make products such as ice cream. However, the salt added to the ice creates a high content of saltwater solution that is not good for the environment upon disposal, and is especially harmful to plants and animals.

Freezers have been used to lower the temperature of a product such as beer to a point below freezing in order to obtain frost or ice crystals in the beer. This method works but it does limit the enjoyment of the beverage to only at home, as these freezers are not portable. Beer mugs and steins are also commonly stored in the freezer to quickly chill the beer that is poured into them. Again, this method is not portable and requires a freezer.

Products such as dry ice have been used to keep meats and beverages cold or any other product that needs to be kept at temperatures below freezing. However, dry ice can be very dangerous if not handled properly and it is not readily available.

Ice and coolers are commonly used to travel to the beach, camping, parks, and other outdoor or indoor recreation. However, ice cannot bring beer or other products to a temperature below freezing. Also, using regular ice to cool beer allows it to become warm before an individual can finish drinking it. While beverage sleeves, generally made of neoprene, can help keep a can or glass bottle cold on a hot day by slipping over the bottle, the beverage still loses its chill over time.

Therefore, there remains a need for a method of cooling products below freezing that is portable, easy to use, and environmentally friendly.

### SUMMARY OF THE INVENTION

The present invention provides for a composition for lowering the freezing point of water including at least one compound chosen from sodium chloride in an amount from 0.0001% to 100% volume, magnesium chloride in an amount from 0.0001% to 100% volume, calcium chloride in an amount from 0.0001% to 100% volume, potassium in an amount from 0.0001% to 100% volume, potassium chloride in an amount from 0.0001% to 100% volume, ammonia in an amount from 0.0001% to 100% volume, calcium carbonate in an amount from 0.0001% to 100% volume, magnesium carbonate in an amount from 0.0001% to 100% volume, acetate acid in an amount from 0.0001% to 100% volume, potassium acetate in an amount from 0.0001% to 100% volume, and urea in an amount from 0.0001% to 100% volume.

The present invention provides for a pretreated product for keeping an item cold including the composition mixed with water.

The present invention provides for a kit including the composition, instructions for use, measuring aids, and stirrers.

The present invention provides for a method of lowering the freezing point of water, by adding the composition to water, and lowering the freezing point of water by the composition interacting with the water.

### DESCRIPTION OF THE DRAWINGS

Other advantages of the present invention are readily appreciated as the same becomes better understood by reference to the following detailed description when considered in connection with the accompanying drawings wherein:

FIG. 1A is a side view of an untreated frozen ice cube, and FIG. 1B is a side view of a treated frozen ice cube;

FIG. 2A is a side view of untreated water, and FIG. 2B is a side view of treated water; and

FIG. 3A is a side view of a treated ice cube, and FIG. 3B is a side view of a treated ice cube including dye.

### DETAILED DESCRIPTION OF THE INVENTION

The present invention provides for compositions and methods of lowering the temperature and/or freezing point of water and/or ice with an additive that is environmentally friendly and easy to use.

“Water” as used herein, can refer to the gaseous (i.e. vapor), liquid, or solid (ice) state of water (H₂O). The composition of the present invention can be added to water in any state, whether gaseous, liquid, or solid.

The composition is an additive for water including at least one compound chosen from sodium chloride in an amount from 0.0001% to 100% volume, magnesium chloride in an amount from 0.0001% to 100% volume, calcium chloride in an amount from 0.0001% to 100% volume, potassium in an amount from 0.0001% to 100% volume, potassium chloride in an amount from 0.0001% to 100% volume, ammonia in an amount from 0.0001% to 100% volume, calcium carbonate in an amount from 0.0001% to 100% volume, magnesium carbonate in an amount from 0.0001% to 100% volume, acetate acid in an amount from 0.0001% to 100% volume, potassium acetate in an amount from 0.0001% to 100% volume, and urea in an amount from 0.0001% to 100% volume. Preferably, combinations of at least two compounds can be used. Most preferably, the additive includes at least sodium chloride in an amount from 0.0001% to 99.999% and magnesium chloride in an amount from 0.0001% to 99.999%. Any other compound can also be used that generates more ions in water than sodium chloride. The composition can be environmentally friendly by reducing the amount of sodium chloride in the composition to a point that will not harm plants or animals and increasing the amount of safer and more environmentally friendly compounds, for example, by combining sodium chloride (87%) with 11% magnesium chloride, 1% calcium chloride, and 1% potassium further described below. This creates an environmentally friendly product, and at the same time creates an environment below freezing to keep products colder.

The composition can be in any desired form, such as, but not limited to, powder, granular, flake, pellet, rock, or any other form that remains in a solid-state. Alternatively, the composition can be in a liquid or gaseous form. Different compounds in the composition can also be in different states as desired. For example, compounds can be in solid, liquid, and gaseous states when added to the water. The compounds can be in a liquid form that can be mixed or a solid and liquid and or solid, liquid, and gas form. The solid form can be achieved in many ways. It can be ground up into a powder mixture and then made into a granular, pellets, flakes, or rock form. The solid form can also be the compounds combined in a lose mixture and applied in this form.

The composition can be packaged in a porous packet that releases the composition into water over time through pores. The pores can be of a suitable size to allow the compounds in the composition to pass through at any desired rate. The porous packet can be in any suitable form that allows the composition to pass through, such as, but not limited to, a mesh, a membrane, or gel. The porous packet can itself be dissolvable over time in the water, non-dissolvable, and/or can be biocompatible. Materials used for the porous packet can include, but are not limited to, polypropylene, cellulose, collagen, plastics, metal wire, calcium alginate gel, or hydrogels.

The composition can also include a dye in a staining or non-staining form to act as a visual aid to indicate that the composition is present in the water, in either natural or synthetic form, and in any color desired. The dye can also be biocompatible. The composition can also include glowing additives that cause the product to glow, such as by luminescence (i.e. a luminescent agent) and/or bioluminescence (i.e. a bioluminescent agent). The bioluminescence can be phosphorescence, chemiluminescence (such as with phosphorus, luciferin, or aequorin), or radioluminescence (tritium, radium). The glowing additives can be used as a visual aid at night.

The present invention provides for a method of lowering the freezing point of water, by adding the composition to water, and the composition interacting with the water to lower its freezing point. The interaction of the molecules of the composition with the molecules of water alter the freezing point. As described above, the water can be in a gaseous, liquid, or solid state. By lowering the freezing point, the resulting ice temperature when the water freezes can be greatly decreased, from its normal freezing point of 32° F. to a lower temperature. The temperature can be lowered from 31° F. to −20° F. In some cases, the temperature can be lowered as low as −20° F. or even lower. Both the internal and external temperatures of the water can be lowered. The desired temperature can be adjusted based on the compounds present in the composition. The composition can be mixed with the water in any suitable method. For example, just by coming in contact with ice, the composition can interact with the ice to lower the freezing point. It can be poured or injected into the water and mixed by hand or mechanically mixed in as a liquid solid or gas form into the water before it becomes frozen. The composition can also be added to ice in a solid, liquid, or gas form by sprinkling or pouring over the ice. When the composition is included in a porous packet, the porous packet can be placed on the water (such as in between a layer of ice) and the composition is released over time into the water. The amount ranges from 0.0001% to 99.999% volume to water ratio: the higher the percentages, the lower the freeze point becomes.

The composition can be used and added to water before the freezing point of water has been reached, which allows for a manufacturer to freeze the water into a solid form to sell it in a pretreated state eliminating the need for the consumer to treat it. This allows for the composition to be exactly measured at a manufacturing facility to provide the correct ratio of water to the composition to provide a specific temperature desired. Therefore, the present invention provides for a product including the composition and water premixed. Such a product can take many forms, such as, but not limited to, cooling freezer packs, drink holders, bottles of water, bags of ice, or lined freezer bags to transport products from the grocery store. The composition can include any of the dyes or glowing additives as described above.

Alternatively, the composition can be directly sold to the consumer and they can treat the water themselves by adding the composition to the water. A kit can be provided that includes the composition as well as instructions for use, and any additional needed materials such as measuring aids (cups, scoops, spoons in a predetermined volume) or stirrers (paddle sticks, spoons, or any suitable stirring device), as well as any of the dyes or glowing additives described above.

The composition can be used to lower the freezing point of water to aid in cooling beverages, ice cream, meat, lab specimens, cooling chemical compounds (such as those that have a chemical reaction like epoxy that generate heat and by cooling it extends the workability time), or any other product that is desired to be cooled.

The composition of the present invention provides advantages over the prior art because it can provide temperatures below freezing where a freezer is not able to be used (i.e. it can be used portably at the beach or a park), it is easy to add to water, and it does not provide harmful effects to the environment.

The invention is further described in detail by reference to the following experimental examples. These examples are provided for the purpose of illustration only, and are not intended to be limiting unless otherwise specified. Thus, the invention should in no way be construed as being limited to the following examples, but rather, should be construed to encompass any and all variations which become evident as a result of the teaching provided herein.

### EXAMPLE 1

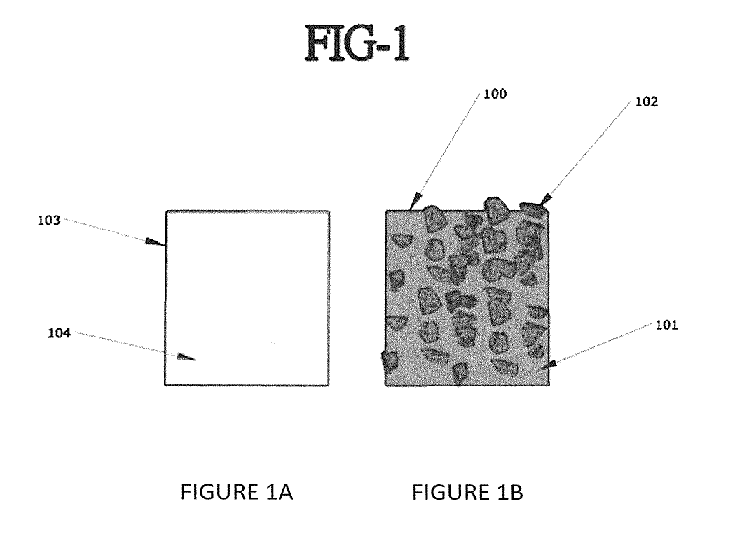

FIG. 1A shows an untreated ice cube 103, with the inside of the ice cube 104 remaining clear before the composition of the present invention has been added. FIG. 1B shows a treated ice cube 100 after the ice cube 100 has reached its freezing point of 32° F. or below, and the composition of the present invention 102 has been added. In this example, the composition includes a combination of 11% magnesium chloride, 87% sodium chloride, 1% calcium chloride, and 1% potassium. This is one example of a combination of compounds that has proved to be environmentally friendly. However, the other combinations of compounds described above can also achieve similar results. The inside of the treated ice cube is shown at 101 as the composition 102 and the dye interact with the ice cube increasing the ratio of the composition to water, thereby changing the inside color. The composition 102 is added in a solid rock state.

### EXAMPLE 2

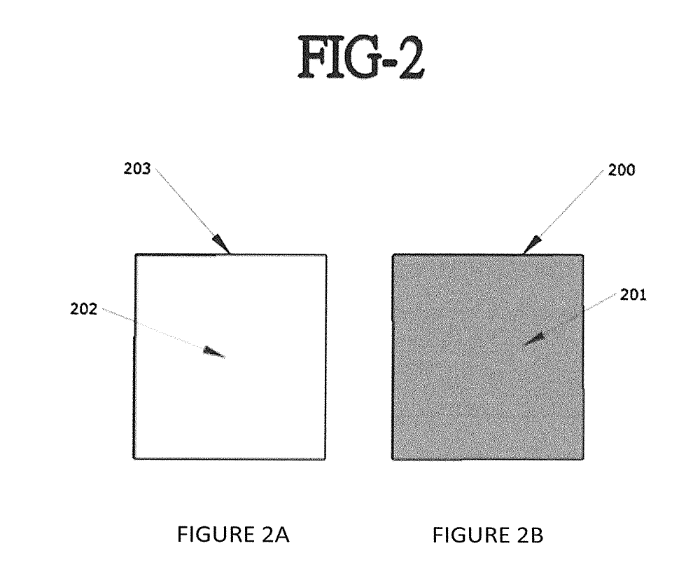

FIG. 2A shows a cube of water 203 in an unfrozen state in an untreated state. The inside of the cube of water in the untreated state is shown at 202. FIG. 2B shows a cube of water 200 in a treated state of being treated with the composition in a liquid, solid, or gaseous form or a combination of up to all three, prior to its frozen state. This allows for a product that can be put into a freezer or ice maker and brought to a considerably lower temperature than could ever be achieved with untreated ice. The inside 201 of the right cube of water in a liquid state has been treated with the composition and in this version a dye has been added to the water to work as an indicator as to the presence of the material or materials.

### EXAMPLE 3

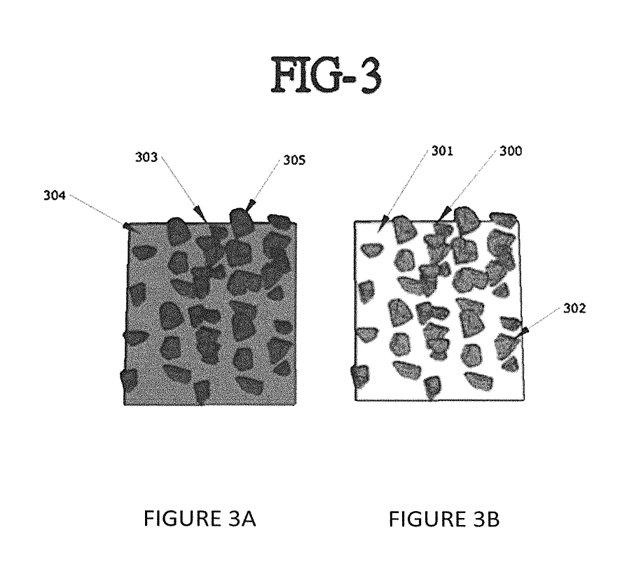

FIG. 3A shows an ice cube 303 treated with the composition 305 in solid state and having a dye 304 to allow for a visual aid in detecting the presence of the composition. FIG. 3B shows an ice cube 300 treated with the composition 302 in solid state, without being treated with a dye as shown by the inside 301 having no indication of the dye.

Throughout this application, various publications, including United States patents, are referenced by author and year and patents by number. Full citations for the publications are listed below. The disclosures of these publications and patents in their entireties are hereby incorporated by reference into this application in order to more fully describe the state of the art to which this invention pertains.

The invention has been described in an illustrative manner, and it is to be understood that the terminology, which has been used is intended to be in the nature of words of description rather than of limitation.

Obviously, many modifications and variations of the present invention are possible in light of the above teachings. It is, therefore, to be understood that within the scope of the appended claims, the invention can be practiced otherwise than as specifically described.

What is claimed is:

1. A composition for lowering the freezing point of water comprising:
at least one compound chosen from the group consisting of sodium chloride in an amount from 0.0001% to 100% volume, magnesium chloride in an amount from 0.0001% to 100% volume, calcium chloride in an amount from 0.0001% to 100% volume, potassium in an amount from 0.0001% to 100% volume, potassium chloride in an amount from 0.0001% to 100% volume, ammonia in an amount from 0.0001% to 100% volume, calcium carbonate in an amount from 0.0001% to 100% volume, magnesium carbonate in an amount from 0.0001% to 100% volume, acetate acid in an amount from 0.0001% to 100% volume, potassium acetate in an amount from 0.0001% to 100% volume, and urea in an amount from 0.0001% to 100% volume.

2. The composition of claim 1, wherein said composition includes sodium chloride in an amount from 0.0001% to 99.999% volume and magnesium chloride in an amount from 0.0001% to 99.999% volume.

3. The composition of claim 1, wherein said composition includes sodium chloride in an amount of 87% volume, magnesium chloride in an amount of 11% volume, calcium chloride in an amount of 1% volume, and potassium in an amount of 1% volume.

4. The composition of claim 1, wherein said composition is in a form chosen from the group consisting of powder, granular, flake, pellet, and rock.

5. The composition of claim 1, wherein said compounds in said composition are in a state chosen from the group consisting of solid, liquid, gaseous, and combinations thereof.

6. The composition of claim 1, wherein said composition is contained within a porous packet that releases said composition into water over time.

7. The composition of claim 6, wherein said porous packet is in a form chosen from the group consisting of mesh, membrane, and gel.

8. The composition of claim 6, wherein said porous packet is made of a material chosen from the group consisting of polypropylene, cellulose, collagen, plastics, metal wire, calcium alginate gel, and hydrogels.

9. The composition of claim 1, further including a dye.

10. The composition of claim 1, further including a glowing additive chosen from the group consisting of a luminescent agent and a bioluminescent agent.

11. A pretreated product for keeping an item cold, comprising at least one compound chosen from the group consisting of sodium chloride in an amount from 0.0001% to 100% volume, magnesium chloride in an amount from 0.0001% to 100% volume, calcium chloride in an amount from 0.0001% to 100% volume, potassium in an amount from 0.0001% to 100% volume, potassium chloride in an amount from 0.0001% to 100% volume, ammonia in an amount from 0.0001% to 100% volume, calcium carbonate in an amount from 0.0001% to 100% volume, magnesium carbonate in an amount from 0.0001% to 100% volume, acetate acid in an amount from 0.0001% to 100% volume, potassium acetate in an amount from 0.0001% to 100% volume, and urea in an amount from 0.0001% to 100% volume mixed with water.

12. The pretreated product of claim 11, wherein said pretreated product is chosen from the group consisting of cooling freezer packs, drink holders, bottles of water, bags of ice, and lined freezer bags.

13. A kit for lowering the freezing point of water, comprising the composition of claim 1 and instructions for use.

14. The kit of claim 13, further including a measuring aid, stirrers, and at least one additive chosen from the group consisting of dye and glowing additives.

15. A method of lowering the freezing point of water, including the steps of:
adding a composition comprising at least one compound chosen from the group consisting of sodium chloride in an amount from 0.0001% to 100% volume, magnesium chloride in an amount from 0.0001% to 100% volume, calcium chloride in an amount from 0.0001% to 100% volume, potassium in an amount from 0.0001% to 100% volume, potassium chloride in an amount from 0.0001% to 100% volume, ammonia in an amount from 0.0001% to 100% volume, calcium carbonate in an amount from 0.0001% to 100% volume, magnesium carbonate in an amount from 0.0001% to 100% volume, acetate acid in an amount from 0.0001% to 100% volume, potassium acetate in an amount from 0.0001% to 100% volume, and urea in an amount from 0.0001% to 100% volume to water; and
lowering the freezing point of water by the composition interacting with the water.

16. The method of claim 15, wherein the water is in a state chosen from the group consisting of gaseous, liquid, and solid.

17. The method of claim 15, wherein said lowering step is further defined as lowering the freezing point to a temperature between 31° F. and −20° F.

18. The method of claim 15, wherein said lowering step is further defined as lowering the freezing point to a temperature lower than −20° F.

19. The method of claim 15, further including the step of lowering the internal and external temperature of the water.

20. The method of claim 15, wherein said adding step further includes the step of mixing the composition with the water by a method chosen from the group consisting of sprinkling, pouring, injecting, hand mixing, and mechanically mixing.

21. The method of claim 15, wherein said adding step is further defined as adding a porous packet that releases the composition into the water over time.

22. The method of claim 21, wherein the porous packet is in a form chosen from the group consisting of mesh, membrane, and gel.

23. The method of claim 21, wherein the porous packet is made of a material chosen from the group consisting of polypropylene, cellulose, collagen, plastics, metal wire, calcium alginate gel, and hydrogels.

24. The method of claim 15, wherein the porous packet dissolves into the water over time.

25. The method of claim 15, wherein the composition further includes a dye.

26. The method of claim 15, wherein the composition further includes a glowing additive chosen from the group consisting of a luminescent agent and a bioluminescent agent.
